(19) United States
(12) Patent Application Publication
(10) Pub. No.: US 2024/0020243 A1
(43) Pub. Date: Jan. 18, 2024

(54) MODIFICATION OF AUDIO SIGNALS BASED ON AMBIENT NOISE COLLECTED BY SPEAKERS

(71) Applicant: HEWLETT-PACKARD DEVELOPMENT COMPANY, L.P., Spring, TX (US)

(72) Inventors: Cheng-Yan Chiang, Taipei City (TW); James L. Mondshine, Spring, TX (US); Charles Shaver, Spring, TX (US); Khoa Huynh, Spring, TX (US); Jia-Hung Lai, Taipei City (TW); Bing-Hao Cheng, Taipei City (TW); Kuang-Che Teng, Taipei City (TW); Chin-Yu Wang, Taipei City (TW)

(73) Assignee: HEWLETT-PACKARD DEVELOPMENT COMPANY, L.P., Spring, TX (US)

(21) Appl. No.: 17/914,604

(22) PCT Filed: Apr. 29, 2020
(86) PCT No.: PCT/US2020/030449

§ 371 Date: Sep. 26, 2022

(51) Int. Cl. G06F 13/10

(52) U.S. Cl. CPC G06F 13/10; G06F 2213/40

(57) ABSTRACT

In an example in accordance with the present disclosure, a method is described. According to the method, boundary values for a setting for a signal between a compute device and a peripheral device are determined. A target value for the setting is determined. The target value is a value between determined boundary values. The setting for the signal is adjusted to match the target value.

### BACKGROUND

Compute devices can be connected to any number of peripheral devices to increase their functionality. For example, a monitor or multiple monitors may be coupled to a compute device to provide a visual interface for the user. As another example, an input device such as a mouse, keyboard, touch pad, etc. may be coupled to the compute device. As yet another example, the peripheral device may add functionality to the compute device. Examples of functionality-adding peripheral devices include a storage device, a scanner, a printer, and/or a projector.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a compute device for adjusting signal settings, according to an example of the principles described herein.

FIG. 2 is a flowchart of a method for adjusting signal settings, according to an example of the principles described herein.

FIG. 3 is a block diagram of a compute device for adjusting signal settings, according to an example of the principles described herein.

FIG. 4 is a circuit diagram of a signal tuning device for adjusting signal settings, according to an example of the principles described herein.

FIG. 5 is a circuit diagram of a signal tuning device for adjusting signal settings, according to another example of the principles described herein.

FIG. 6 is a flowchart of a method for adjusting signal settings, according to another example of the principles described herein.

FIG. 7 is a diagram of states of a port used for adjusting a drive strength setting, according to an example of the principles described herein.

FIG. 8 is a flowchart of a method for adjusting a drive strength setting, according to another example of the principles described herein.

FIG. 9 depicts a non-transitory machine-readable storage medium for adjusting signal settings, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations that coincide with the description; however, the description is not limited to the examples and/or implementations provided in the drawings.

### DETAILED DESCRIPTION

Peripheral devices refer to auxiliary devices that connect to, and work with, a compute device in some way. Peripheral devices may be of a variety of types. For example, peripheral devices may be input devices such as microphones, keyboards, a mouse, and others. In some examples, a peripheral device may be an output device such as a monitor, a projector, or a virtual reality headset. In yet another example, the peripheral device may be an external memory device. While specific reference is made to a few example peripheral devices, there are a wide variety of peripheral devices that could be coupled to a compute device and the list of peripheral devices is sure to expand over time.

While such peripheral devices increase the functionality of a compute device, some characteristics may hinder their more complete integration. For example, compute devices and peripheral devices may rely on a protocol to communicate one with another. As a particular example, a protocol may be defined for devices that connect via a universal serial bus (USB) connection. However, notwithstanding both the compute device and the peripheral device complying with a particular protocol, it may be the case that a compatibility issue may still exist. Accordingly, when a peripheral device, such as a USB storage disk or a USB keyboard/mouse, is plugged into a port of the compute device, the controller of the compute device may not recognize the peripheral device and the peripheral device may malfunction or become unusable.

In some examples, this incompatibility may result when the signal settings between the peripheral device and the compute device are misaligned. For example, one setting of the signal is the drive strength of a signal applied by a compute device to communicate with the peripheral device. There are certain values for drive strength when a peripheral device may not be detected, or may be detected, but may function improperly. For example, a controller of a compute device may utilize different drive strength values to drive a signal. However, the drive strengths for which a peripheral device is detectable may include a subset of those values used by the controller.

The subset of drive strengths for which a peripheral device can be detected and for which operation may be carried out as intended varies based on the circumstances. For example, a length of a cable between the compute device and the peripheral device may have an effect on signal degradation where signal quality degrades relative to cable length. Accordingly, a drive strength that detects a peripheral device under one circumstance may not detect a peripheral device under another circumstance.

Whether a peripheral device has been detected and operates as intended are criteria by which the subset of drive strengths, or other settings, are determined. For example, if the compute device can fully enumerate and load the driver for a peripheral device, then the settings are valid.

Accordingly, the present specification describes devices, methods, and machine-readable storage media for addressing this issue. Specifically, the present specification allows for adjustment of the signal settings based on the peripheral device and selection of a setting that ensures the proper detection and operation of that particular peripheral device.

In one particular example, the compute device includes a signal tuning device that includes a variable resistor or a combination of resistors. A controller determines what settings result in detection and identification of a peripheral device and adjusts the variable resistor or combination of resistors such that the signal with those settings is used when driving the particular peripheral device.

Specifically, the present specification describes a compute device. The compute device includes a port to receive a connector of a peripheral device. The compute device also includes 1) a signal generator to drive a signal to the peripheral device via the port and 2) a signal tuning device. The signal tuning device 1) determines boundary values for a setting of the signal, 2) selects a target value for the setting, the target value to be between the boundary values, and 3) adjusts the setting of the signal to the target value.

The present specification also describes a method. According to the method, boundary values for a setting of a signal between a compute device and a peripheral device are determined by a controller. The controller also selects a target value for the setting, which target value is between determined boundary values. The controller also adjusts the setting of the signal to match the target value.

The present specification also describes a non-transitory machine-readable storage medium encoded with instructions executable by a processor. The machine-readable storage medium includes instructions to, when executed by the processor, cause the processor to identify a default value for a setting of a signal between a compute device and a peripheral device. The instructions, when executed by the processor, cause the processor to 1) pass signals with various setting values to the peripheral device and 2) identify for which of the various setting values a port connection state is readable and a peripheral device connected to the port is identifiable. The instructions also, when executed by the processor, cause the processor to determine upper and lower boundary values for the setting where a port connection state is readable and a peripheral device connected to the port is identifiable and select, based on the peripheral device, a target value between the upper and lower boundary values, which setting is applied to the signal.

In these examples, the target value may represent a value centrally disposed within a range wherein the device is identifiable and thereby may reduce any compatibility issues that may result from driving a peripheral device with a predetermined setting value, which single setting value may not properly detect the peripheral device.

In summary, using such a compute device, method, and machine-readable storage medium may, for example, 1) detect and identify a wide variety of peripheral devices; 2) implement settings for a peripheral device communication that are tailored to the peripheral device; 3) prevent potential damage to the peripheral device and/or compute device via improper settings; and 4) provide compatibility with a wide variety of peripheral devices as examples. However, it is contemplated that the devices disclosed herein may address other matters and deficiencies in a number of technical areas, for example.

As used in the present specification and in the appended claims, the term “settings” refers to a characteristic of a signal between a compute device and a peripheral device. Example settings include a drive strength, a disconnect voltage, and a DC level.

As used in the present specification and in the appended claims, the term “a number of” or similar language is meant to be understood broadly as any positive number including 1 to infinity.

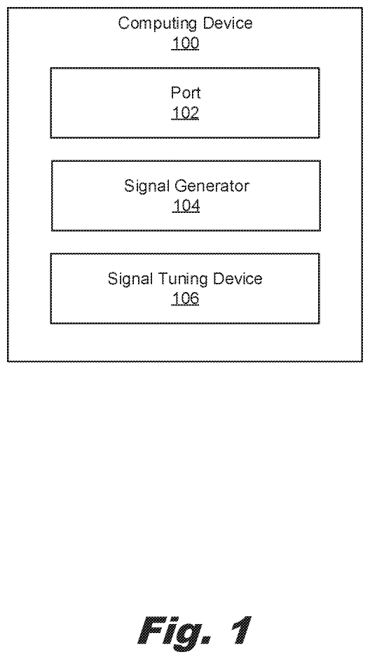

Turning now to the figures, FIG. 1 is a block diagram of a compute device (100) for adjusting signal settings, according to an example of the principles described herein. The compute device (100) may be of a variety of types. For example, the compute device (100) may be a mobile phone, a desktop computer, a laptop computer, a server, a tablet device and a gaming system. While particular reference is made to specific compute devices (100), the principles described herein may be implemented in a variety of different kinds of compute devices (100).

The compute device (100) includes a port (102) to receive a connector of a peripheral device. The port (102) may be of a variety of types. For example, the port (102) may be a universal serial bus (USB) type-C port, a USB 2.0 port, a video graphics array (VGA) port, a digital video interface (DVI) port, DISPLAYPORT™, etc. While specific reference is made to a few types of ports (102), the compute device (100) may include any variety, and any number of ports (102). Through such a port (102), a variety of peripheral devices may be coupled to the compute device (100).

The compute device (100) also includes a signal generator (104) that drives a signal to a peripheral device via the port (102). That is, power and data from a controller of the compute device (100) allow the peripheral device to operate. The signal generator (104) transmits, and in some cases conditions, the power and data signals from the controller of the compute device (100). The signal generator (104) may take a number of forms including a chipset which includes electronic components that manage the transfer of data between the peripheral device and the compute device (100). Such a chipset may determine which peripheral devices are connected to the compute device (100), whether they are compatible with the compute device (100), and also directs the operation of the peripheral devices.

The signal that the signal generator (104) drives has a variety of settings. As described above, these settings may dictate how, and if, a peripheral device is detected and functions. Also as described below, these settings may be adjusted based on the peripheral device and/or the port (102). In some examples, the settings that are tunable and thereby adjusted are selected from the group consisting of a drive strength, a disconnect voltage, and a direct current level. In some cases, one of the settings are tuned and in other examples multiple of the settings are tuned to a peripheral device.

In some examples, the drive strength is made up of various parameters of a signal between a peripheral device and the compute device (100). These signal parameters may include current, voltage, frequency, pre-emphasis, and de-emphasis. As used herein, the term “pre-emphasis” refers to signal processing which boosts a strength of a portion of a signal at certain frequencies, which may be high frequencies, before sending out the signal. Doing so enhances the overall signal-to-noise ratio. De-emphasis by comparison reverses the process such that the original signal is restored at a receiver side. While particular reference is made to a drive strength formed of multiple parameters, in some examples, the drive strength may be made up of a single parameter.

As described above, different drive strengths may affect whether a peripheral device is detected or not. For example, there may be drive strength values for which the peripheral device is not properly detected and/or does not properly function. When tuning the drive strength, the parameters (such as voltage and currents) can be tuned, either to increase or decrease their values. In some examples, the degree of tuning may be measured in decibels (dB) which is a logarithmic unit of measurement and a indicates a ratio between values. For example, for voltage ratio, 20 dB indicates that compared to the initial voltage value, the present voltage has been to tuned to be 10 times greater than an original value. While particular reference is referend to a logarithmic measure of a degree of tuning, a degree of tuning may be measured using other criteria.

As a specific example, when tuning the drive strength, the signal tuning device (106) may start by tuning a voltage. If desired, the signal tuning device (106) may tune a current. In some examples, the signal tuning device (106) may proceed to tune other parameters, such as pre-emphasis and de-emphasis.

Another such setting is the disconnect voltage. The disconnect voltage refers to a threshold value at which the compute device (100) disconnects a link between the compute device (100) and the peripheral device. That is, if the voltage along the transmission cable between the compute device (100) and the peripheral device is greater than the disconnect voltage, then the compute device (100) may temporarily or permanently sever the connection.

Direct current (DC) level is an example of another setting. DC level refers to the voltage level when the signal between the compute device (100) and the peripheral device is at direct current.

As described above, each of these settings, if outside of particular boundaries may affect the operation and detectability of peripheral devices coupled to the compute device (100). For example, if the drive strength is outside of a particular range, a peripheral device may not be detected. As another example, if the DC level exceeds the disconnect voltage, then the compute device (100) may terminate the connection. Accordingly, the signal tuning device (106) may adjust the DC level to provide a buffer between a DC level and a disconnect voltage so as to prevent inadvertent disconnection. In some examples, the buffer may be selected based on the port (102) and type of peripheral device connected to the compute device (100). For example, if a peripheral device/port connection is prone to disconnect, a larger buffer may be selected as compared to a connection that is not prone to disconnect. By comparison, if a peripheral device/port connection is not prone to disconnect a small buffer may be selected as compared to a connection that is more prone to disconnect.

Accordingly, the compute device (100) includes a signal tuning device (106) to adjust any or multiple of these settings to enhance the performance, connection, and communication between the compute device (100) and the peripheral device. Specifically, the signal tuning device (106) includes hardware components such as electrical circuitry and a controller, which controller may include a processor and memory. The signal tuning device (106) may determine boundary values for a setting, or settings, of the signal and then selects a target value for the setting(s). The target value may be between the boundary values. For example, with regards to driving strength, the controller of the compute device (100) may have the capability of driving peripheral devices at values between −3 dB and +3 dB from an original value, which original value may be a default value determined by a controller of the signal tuning device (106). However, the peripheral device may be detectable for a subset of those values. Accordingly, the signal tuning device (106) determines the boundaries of the drive strength for which the device is detectable. As a particular example, a peripheral device may be identifiable when a drive strength of −1 dB and +2 dB from the original value is used.

The signal tuning device (106) also selects a target value for the setting. The target value may be between the boundary values. For example, given boundary values of −1 dB and +2 dB, the signal tuning device (106) may select a target value of +1 dB from an original value for the drive strength. This value represents a drive strength that for this particular peripheral device, results in the peripheral device being detected such that data may be optimally transmitted with reduced risk of losing the connection or malfunctioning based on a less than ideal drive strength. Example boundary values of the DC level may between 350 millivolts (mV) and 450 mV and example boundary values for the disconnect voltage may be between 550 mV and 625 mV. Note that while particular reference is made to specific values, actual drive strengths may not be determined, but the system may operate based on register values.

In some examples, the determined values are port/peripheral device specific, given that there are many peripheral devices and ports vary from one to the next, even when from the same manufacturer. Accordingly, the compute device (100) may tune the signal drive strength when a peripheral device is attached to a port (102) and may tune the signal again when the peripheral device is attached to another port (102) of the compute device (100). Accordingly, the present compute device (100) customizes a signal based on the peripheral device that is attached. With a target value selected, the signal tuning circuit (106) adjusts the setting of the signal to the target value. As specific examples, the signal tuning device (106) may adjust a frequency, current, and/or voltage associated with the signal.

This may include adjusting a setting of the signal generator (104). For example, the signal generator (104) may include some registers/strapping signals as parameters for driving the signal. Accordingly, after the signal tuning device (106) determines the target value, the signal tuning device (106) may write that value into a register or program a pin connected to the signal generator (104) to have the associated strapping voltage such that the signal generator (104) generates the signal having those settings.

A specific example of such a tuning operation is now provided. In this example, drive strength for a USB 2.0 port (102) from a chipset signal generator (104) is tuned. In this example, the signal tuning device (106) may check the associated memory-mapped I/O address, which in this example may be 0x0003F380. Corresponding register values may be “0x03, 0x03, 0x03, 0x03, 0x00, 0x01, 0x06, 0x03, 0x01.” In this example, byte indicates a parameter. Specifically, in this example the mapping may be 1) disconnect threshold adjustment, range 0-0x7; 2) squelch threshold adjustment, range 0-0x7; 3) FS/LS source impedance adjustment, range 0-0xF; 4) HS transmitter pre-emphasis current control, range 0-0x3; 5) HS transmitter pre-emphasis duration control, range: 0-0x1; 6) HS transmitter rise/fall time adjustment; range: 0-0x3; 7) HS DC voltage level adjustment, range 0-0xF; 8) transmitter high-speed crossover adjustment; range 0-0x3; 9) USB source impedance adjustment, range 0-0x3. Accordingly, in this example, the signal tuning device (106) tries different combinations of the different drive strength parameters (e.g., current, voltage, frequency, pre-emphasis, and de-emphasis). That is, the signal tuning circuit (FIG. 1, 106) may adjust the different parameters in a variety of combinations to determine the target drive strength.

In an example, where the signal generator (104) includes a re-driving circuit, which re-driving circuit may support strapping for drive strength setup, the signal tuning circuit (106) may adjust the voltage level of a voltage divider to indicate how to change the parameter values.

Accordingly, the compute device (100) as depicted in FIG. 1 generates a customized signal which is specific to the peripheral device. Being specific to the peripheral device indicates that the signal is not necessarily a default and pre-programmed signal, but may account for specific characteristics of the peripheral device and/or the port (102). For example, there may be characteristics of a peripheral device that may render a default signal insufficient to detect and communicate with the device. The compute device (100), by determining the settings for the signal while the peripheral device is connected, generates a customized signal that is specific to the peripheral device.

As it is specific to the peripheral device, a user can be assured that the likelihood of miscommunication or non-detection are reduced, for example. That is, as described above, the operation of the signal tuning device (106) to determine boundary values, select a target value, and adjust the settings is specific to the peripheral device. Accordingly, rather than relying on a default signal, which may or may not work with a particular peripheral device, a signal is generated that is customized for the peripheral device. In some examples, the signal tuning device (106) is activated responsive to a connection of the peripheral device to the port (102).

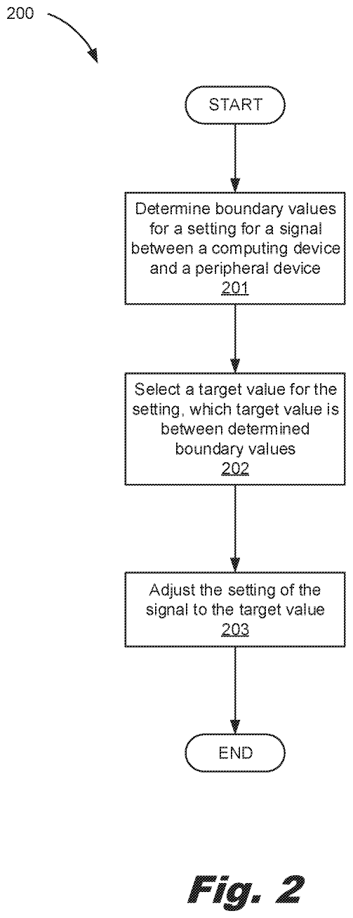

FIG. 2 is a flowchart of a method (200) for adjusting signal settings, according to an example of the principles described herein. As described above, the signal tuning device (FIG. 1, 106) may determine (block 201) boundary values for a setting for a signal between a compute device (FIG. 1, 100) and a peripheral device. The boundary values may indicate the subset of possible setting values for which a peripheral device may be detected and operate as intended. For example, as described above, if a disconnect voltage is set close to a DC level, a peripheral device may disconnect before desired or intended. Similarly, if the DC level is set close to a disconnect voltage, the peripheral device may repeatedly disconnect before desired or intended. That is, the disconnect voltage is a voltage wherein a peripheral device is disconnected to protect the peripheral device and/or the compute device. If the DC level is close to this disconnect voltage, it may result in the peripheral device operating at a state where it is frequently disconnected, which may be frustrating to a user and may result in early wear of the peripheral device. Accordingly, the signal tuning circuit (FIG. 1, 106) may determine boundary values that prevent or reduce instances of premature disconnection, dangerous operation, and/or inefficient performance.

As a specific example of adjusting a drive strength, the signal tuning device (FIG. 1, 106) may pass a series of drive strengths to determine for which drive strengths the port (FIG. 1, 102) connection state is readable and whether the peripheral device attached thereto is identifiable. Those states for which a port (FIG. 1, 102) connection state is readable and the peripheral device identifiable indicates the boundary values for the drive strength.

Similarly, the signal tuning device (FIG. 1, 106) may pass a series of disconnect voltages to determine at which point a peripheral device is disconnected. In this example, a lower boundary value may be a lowest voltage at which the peripheral device is disconnected and the upper boundary may be identified from information associated with a compute device (FIG. 1, 100), such as information from a manufacturer of the peripheral device, port (FIG. 1, 102), or compute device (FIG. 1, 100). For example, manufacturing specifications may identify a particular disconnect voltage, and the signal tuning device (FIG. 1, 106) may, starting at a low value, pass various voltages to the peripheral device. The lowest voltage at which the peripheral device is disconnected may be identified as the lower boundary. In this example, the target value for the disconnect voltage may be between the lower boundary and the upper boundary.

Similarly, the signal tuning device (FIG. 1, 106) may pass a series of DC levels to determine for which DC levels the port (FIG. 1, 102) connection state is readable and whether the device attached thereto is identifiable. Those states for which a port (FIG. 1, 102) connection state is readable and the peripheral device identifiable indicates the boundary values for the DC levels.

With boundary levels determined, the signal tuning device (FIG. 1, 106) may select (block 202) a target value for the setting, which target value is between the determined boundary values. In some examples, this may be include selecting an average of an upper and lower boundary value. As another example, the signal tuning device (FIG. 1, 106) may select a target value that is ⅓ or ¼ of the way between the upper and lower boundary values as measured from the lower boundary value. That is, in one example, the target value is an average value. However, in other examples, the target value may be a median, a mean, a quarter percentile a ¾ percentile, etc.

With the target value selected (block 202), the signal tuning device (FIG. 1, 106) adjusts (block 203) the setting of the signal to match the target value. That is, the signal tuning device (FIG. 1, 106) may store the determined value to a register, which register may be read by a signal generator (FIG. 1, 104) during driving of the peripheral device. Accordingly, the method (200) provides a customized signal that is tailored for a particular peripheral device such that operation of that peripheral device may be enhanced.

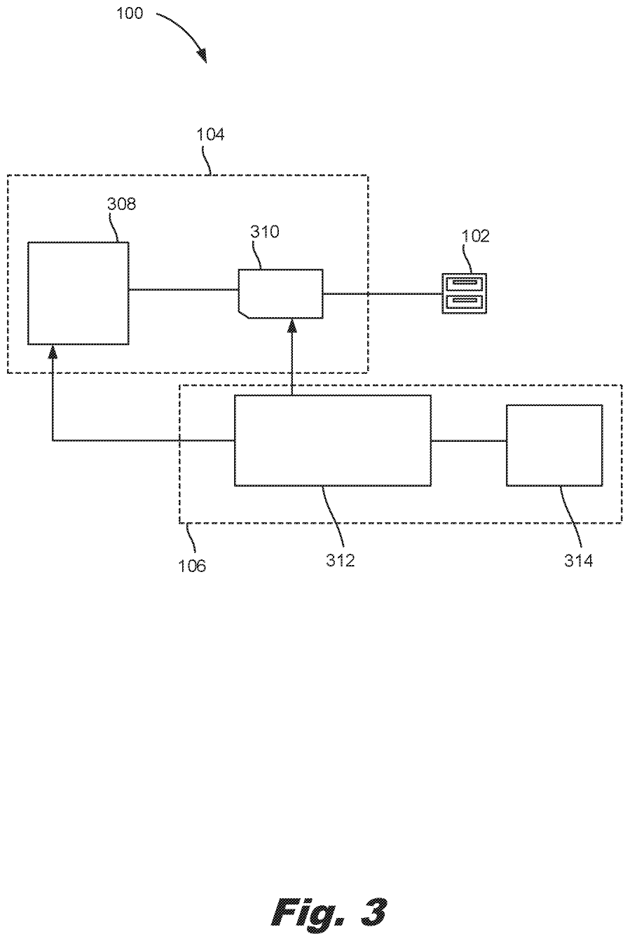

FIG. 3 is a hardware diagram of a compute device (100) for adjusting signal settings, according to an example of the principles described herein. FIG. 3 clearly depicts the port(s) (102) to which a peripheral device is connected.

As described above, the compute device (100) includes a signal generator (104) that drives a signal to a peripheral device connected to the compute device (100) at the port (102). The signal generator (104) may take many forms and may include a chipset (308). As described above, the chipset (308) refers to a combination of electronic components that facilitate, manage, and direct communications between the compute device (100) and the peripheral device(s) attached thereto. In some cases, the signal generator (104) may also include a re-driving circuit (310). That is, in some examples for a variety of reasons, the compute device (100) may not detect a peripheral device after the peripheral device has been attached to the compute device (100). A re-driving circuit (310) amplifies the signal. That is, the re-driving circuit (310) is a circuit to boost the portions of a signal to counteract the frequency-dependent attenuation caused by the interconnect: the central processing unit (CPU) package, system board, connectors and so on.

In some examples, the portion that is boosted is a high frequency portion and may vary based on any number of criteria. For example, a USB protocol may be operated at 5 Gb/s with a 2.5 GHz signal or 10 Gb/s a 5 GHz signal. Accordingly, the high frequency portion that is boosted by the re-driving circuit (310) may vary among protocol and other communication characteristics.

Accordingly, the combination of the chipset (308) and the re-driving circuit (310) may help increase signal quality between the chipset (308) and the port (102) such that peripheral devices may be detected. The signal tuning device (106) accounts for any improper adjustment to signal settings by the re-driving circuit (310) by definitively identifying those settings that function with a particular peripheral device and adjusting the settings of the re-driving circuit (310) to operate under those parameters.

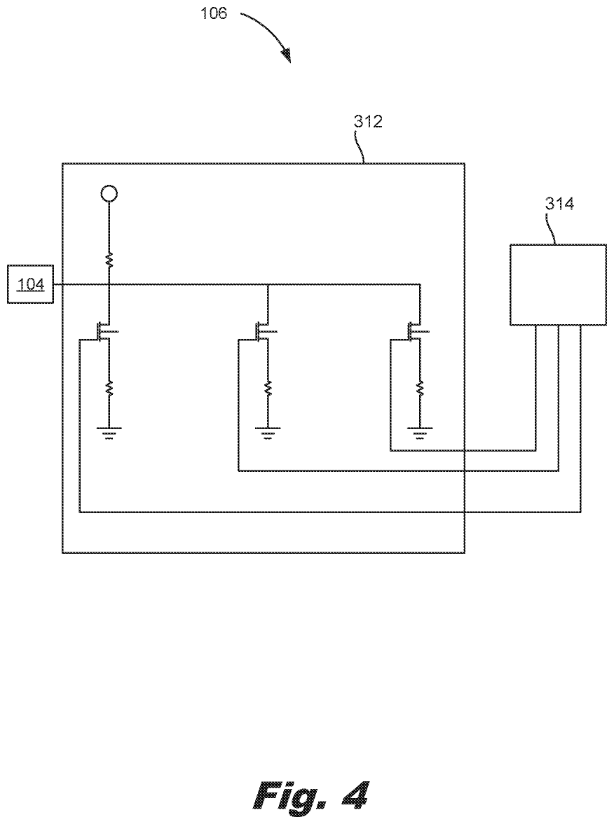

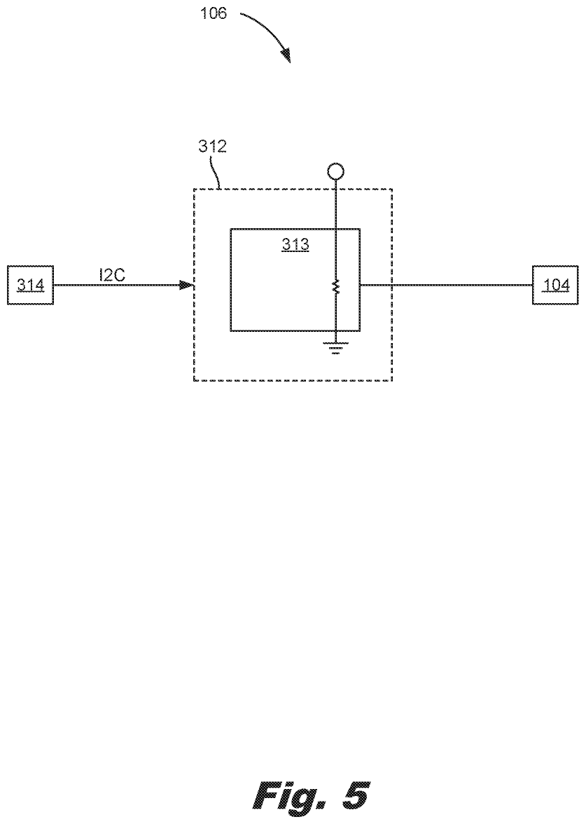

FIG. 3 also depicts the signal tuning device (106). Specifically, the signal tuning device (106) includes a variable resistance device (312) that is used to determine what drive strength, DC level, and disconnect voltage to use with a particular peripheral device and a controller (314). As indicated in FIGS. 4 and 5 below, the variable resistance device (312) may take a variety of forms.

The controller (312) determines the target values for the settings, i.e., the drive strength, disconnect voltage, and DC level, by programming different combinations of resistances across the variable resistance device, checking the port (102) connection status, and determining if a peripheral device connected to the port (102) is identifiable. Using this information, the controller (314) may establish the upper and lower boundary values and selects a target value for one or each of the settings. After the controller (314) completes the search for boundary values and target values, the controller (314) writes these settings into registers, or programs the general-purpose input/output (GPIO) to have a corresponding strapping voltage.

As used in the present specification and in the appended claims, the term, “controller” includes a processor and memory. The processor includes the circuitry to retrieve executable code from the memory and execute the executable code. As specific examples, the controller as described herein may include machine-readable storage medium, machine-readable storage medium and a processor, an application-specific integrated circuit (ASIC), a semiconductor-based microprocessor, a central processing unit (CPU), and a field-programmable gate array (FPGA), and/or other hardware device.

The memory may include a machine-readable storage medium, which machine-readable storage medium may contain, or store machine-usable program code for use by or in connection with an instruction execution system, apparatus, or device. The memory may take many forms including volatile and non-volatile memory. For example, the memory may include Random-Access Memory (RAM), Read-Only Memory (ROM), optical memory disks, and magnetic disks, among others. The executable code may, when executed by the respective component, cause the component to implement at least the functionality described herein.

In some examples, the controller (314) may execute a basic input/output system (BIOS) operation. That is, the controller (314) may include hardware or hardware and instructions to initialize, control, or operate the compute device (100) prior to execution of an operating system (OS) of the compute device (100). A BIOS operation may initialize, control, or operate components such as hardware components of a compute device (100) and may load or boot the OS of compute device (100).

In some examples, the startup may be during a unified extensible firmware interface (UEFI) phase of operation. Similar to BIOS, UEFI initializes different hardware resources and may be compatible with certain components such as large storage drives.

FIG. 4 is a circuit diagram of a signal tuning device (106) for adjusting a signal setting, according to an example of the principles described herein. In this example, the signal tuning device (106) includes multiple voltage dividers coupled in parallel, with each voltage divider including a resistor. As depicted in FIG. 4, each voltage divider is controlled by the controller (314) which can individually open/close transistors of each voltage divider. Accordingly, in this example, a signal is output from the controller (314) and various combinations of the voltage dividers are selectively activated to alter the overall signal output to the signal generator (104). In the example depicted in FIG. 4, when each of the three voltage dividers include resistors of the same value, four different voltage levels could be generated to determine the boundary values and the target value for a particular peripheral device. For example, either, zero, one, two, or three, of the voltage dividers could be activated, resulting in four possible different voltage values which may be available at any time for tuning a signal. By comparison, in an example, the voltage dividers have resistors with different values. In this example, more combinations of resistances are available.

FIG. 5 is a circuit diagram of a signal tuning device (106) for adjusting signal settings, according to another example of the principles described herein. In the example depicted in FIG. 5, rather than relying on multiple voltage dividers, the signal tuning device (106) includes a variable resistor. For example, the circuit component may be a digital potentiometer (313). A digital potentiometer (313) rather than mechanically switching a resistance via different voltage dividers as depicted in FIG. 4, uses digital signals and switches to generate a particular resistance value. In this example, the controller (314) selects a resistance value to program the digital potentiometer (313).

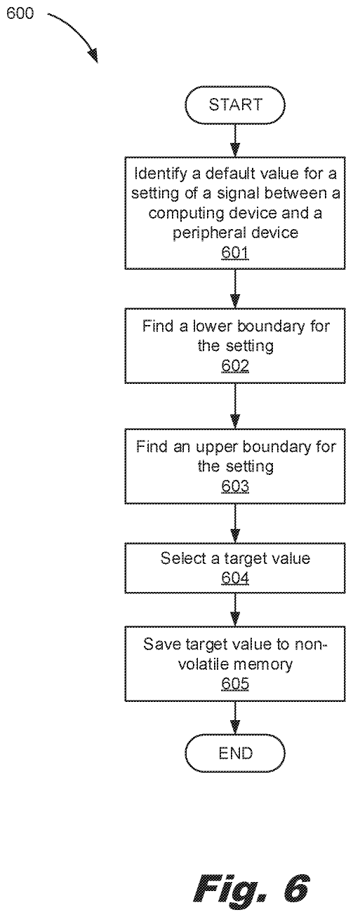

FIG. 6 is a flowchart of a method (600) for adjusting signal settings, according to another example of the principles described herein. According to the method (600), a default setting value for the signal between the compute device (FIG. 1, 100) and the peripheral device is identified (block 601). This default setting may be programmed into the controller (FIG. 3, 314). That is, the controller (FIG. 3, 314) may have a default value that is identified as being compatible with a certain percentage of peripheral devices, or may be selected based on any number of criteria.

As described above, the signal tuning device (FIG. 1, 106) determines boundary values for the setting. More specifically, the signal tuning device (FIG. 1, 106) finds (block 602) a lower boundary for the setting. This may be done by sequentially passing through various values of the setting to determine a lowest value for which both 1) a port (FIG. 1, 102) connection state is readable and 2) a peripheral device coupled to that port is identifiable. That is, the lowest setting value that satisfies both criteria is determined as a lower boundary for the peripheral device. In another example, the signal tuning device (FIG. 1, 106) randomly passes various values for the setting to determine a lowest value for which both 1) a port (FIG. 1, 102) connection state is readable and 2) a peripheral device coupled to that port is identifiable.

In yet another example, specifically referring to a disconnect voltage, the signal tuning device (FIG. 1, 106) may sequentially pass various voltages to determine a lowest value that results in disconnection of the peripheral device.

The signal tuning circuit (FIG. 1, 106) then finds (block 603) an upper boundary for the setting. In an example, this is done by continuing the sequential incrementing of setting values to determine a highest value for which 1) a port (FIG. 1, 102) connection state is readable and 2) a peripheral device coupled to that port is identifiable. When increasing the driving strength, the first driving strength for which one of the criteria no longer is satisfied represents the upper boundary for the peripheral device.

In an example, where the setting is a disconnect voltage, finding (block 603) the upper boundary comprises acquiring the value from information, such as may be provided by a manufacturer of the compute device (FIG. 1, 100), port (FIG. 1, 102), or peripheral device.

A target value is then selected (block 604) between these boundary values, which as described may be an average between the upper and lower boundary or some other value in between the boundary values.

In some examples, this target value is saved (block 605) to non-volatile memory for later re-use. That is, responsive to the same peripheral device being connected to the port (FIG. 1, 102), the target value identified for that peripheral device is recalled from non-volatile memory. That is, as described above, a signal is customized per port/peripheral device connection, and when a peripheral device is connected to a different port (FIG. 1, 102), a new customized signal may be generated. However, storing the target value to non-volatile memory may improve peripheral device connection, for example. Accordingly, after connecting a peripheral device into a port (FIG. 1, 102), the signal tuning device (FIG. 1, 106) saves the information of the peripheral device and its corresponding setting into non-volatile memory. Accordingly, when it is detected that the same peripheral device is connected to the same port (FIG. 1, 102) at a later point in time, the compute device (FIG. 1, 100) may avoid spending time searching for the target value.

In some examples, the data structure as stored in the non-volatile memory may include a field for a profile name as well as fields for each of the settings that have been adjusted. A user, or the compute device (FIG. 1, 100) may populate the profile name field, and the compute device (FIG. 1, 100) during signal tuning may populate the other fields.

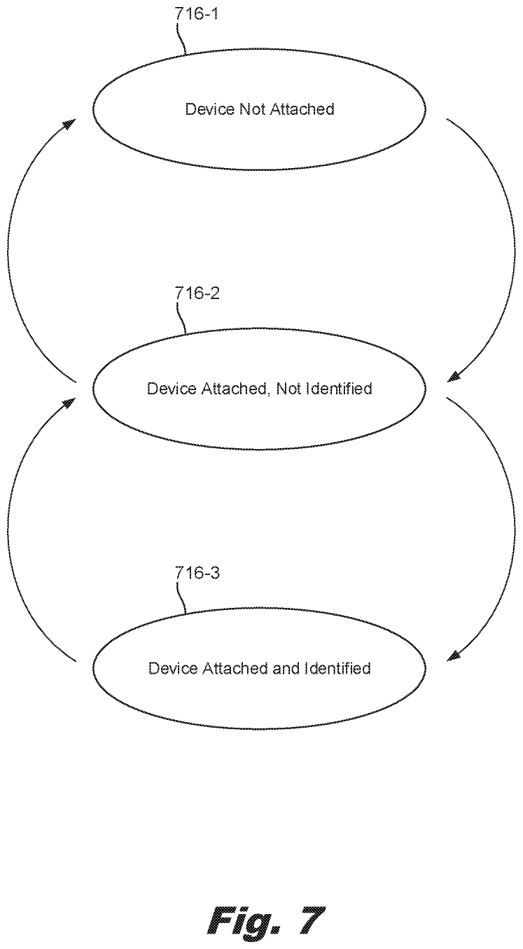

FIG. 7 is a diagram of states (716) of a port (FIG. 1, 102) used for adjusting a drive strength setting, according to an example of the principles described herein. That is, as the drive strength of a signal is increased, the state of the port (FIG. 1, 102) also changes. For example, starting at a default value, the controller (FIG. 3, 314) may detect that the port (FIG. 1, 102) is in a first state (716-1) where the controller (FIG. 3, 314) is not able to determine whether the port (FIG. 1, 102) has a peripheral device connected thereto. As the drive strength increases, either by increasing voltage and/or current individually, the controller (FIG. 3, 314) detects the port (FIG. 1, 102) is in a second state (716-2) where the controller (FIG. 3, 314) is able to determine that the port (FIG. 1, 102) is connected to a peripheral device, but the peripheral device is not identifiable. As the drive strength is further increased, the controller (FIG. 3, 314) detects the port (FIG. 1, 102) is in a third state (716-3) where the controller (FIG. 3, 314) determines that the port (FIG. 1, 102) is connected to a peripheral device and the peripheral device is identifiable. The first voltage at which the port (FIG. 1, 102) is in this third state (716-3) represents the lower boundary value.

To identify the upper boundary value, the controller (FIG. 3, 314) continues to increase the drive strength. As the drive strength is further increased, the controller (FIG. 3, 314) detects that the port (FIG. 1, 102) has returned to the second state (716-2) where the controller (FIG. 3, 314) may determine that the port (FIG. 1, 102) is connected to a peripheral device, but the peripheral device is not identifiable. The drive strength when the port (FIG. 1, 102) leaves the third state (716-3) and re-enters the second state (716-2) represents the upper boundary level.

As the drive strength is further increased, the controller (FIG. 3, 314) detects that the port (FIG. 1, 102) has returned to the first state (716-1) where the controller (FIG. 3, 314) may not be able to determine whether the port (FIG. 1, 102) is connected to a peripheral device.

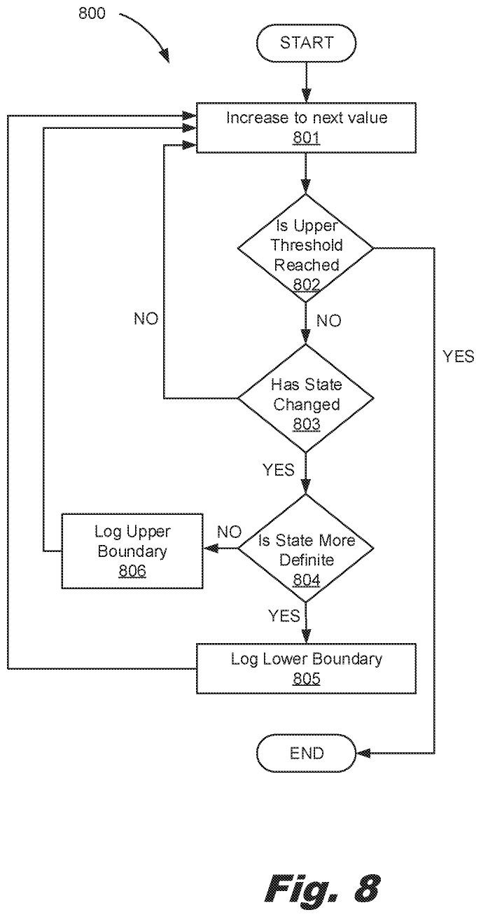

FIG. 8 is a flowchart of a method (800) for adjusting a drive strength setting, according to another example of the principles described herein. As described above in connection with FIG. 7, for different drive strengths, the port (FIG. 1, 102) may be in different states (FIG. 7, 716) which states may be used to determine the boundary values and the target value. That is, according to the method (800), for each of various settings, the signal tuning device (FIG. 1, 106) determines whether, at that setting, a connection state of a port (FIG. 1, 102) is readable and whether a peripheral device connected to the port is identifiable. That is, determining boundary values for the drive strength includes sequentially increasing the drive strength value to identify those setting values for which the connection state of the port (FIG. 1, 102) is readable and the peripheral device connected to the port (FIG. 1, 102) is identifiable. The boundary values represent those drive strengths where the port (FIG. 1, 102) connection state is readable and the peripheral device connected to the port (FIG. 1, 102) is identifiable.

According to a specific example of the method (800), a drive strength is increased (block 801) to a next value. The signal tuning device (FIG. 1, 106) and more specifically a controller (FIG. 3, 314) of the signal tuning device (FIG. 1, 106) determines if the upper threshold is reached (block 802). In this example, the upper threshold represents an upper limit on the controller (FIG. 3, 314) drive strength capability. That is, the upper threshold is a value expected to be greater than the upper boundary for the setting. If the upper threshold is not reached (block 802, determination NO), the signal tuning device (FIG. 1, 106) determines (block 803) if the state (FIG. 7, 716) has changed. That is, whether the port (FIG. 1, 102) has progressed from the first state (FIG. 7, 716-1) to the second state (FIG. 7, 716-2) or from the second state (FIG. 7, 716-2) to the third state (FIG. 7, 716-3). If no state change has occurred (block 803, determination NO), the value is increased (block 801) again. By comparison, if the state has changed (block 803, determination YES), the method (800) continues to determine (block 804) whether the state is more definite.

A state that is more definite is a state where more information regarding the port/peripheral device connection is available as compared to another state. For example, a second state (FIG. 7, 716-2) where a port connection status is identifiable is more definite than a first state (FIG. 7, 716-1) in which a port connection status is not identifiable. As another example, a third state (FIG. 7, 716-3), where a port connection status is identifiable and a peripheral device is identifiable is more definite than a second state (FIG. 7, 716-2) where the port connection status is identifiable, but the peripheral device may not be identifiable. Accordingly, based on collected information during signal tuning, the controller (FIG. 3, 314) may determine what information is available, and based on the information that is available, what state the port (FIG. 1, 102) is in, and whether that state is more definite than a previous state.

For example, going from a second state (FIG. 7, 716-2) where a connection status of a port (FIG. 1, 102) is identifiable to a third state (FIG. 7, 716-3) where a port (FIG. 1, 102) connection status is readable and the peripheral device is identifiable, the controller (FIG. 3, 314) may determine that the third state is more definite as more information is attainable. By comparison, going from a second state (FIG. 7, 716-2) where a port (FIG. 1, 102) connection status is identifiable to a first state (FIG. 7, 716-3) where the port (FIG. 1, 102) connection status is not readable would not be a more definite state change. If the controller (FIG. 3, 314) determines that the state is more definite (block 804, determination YES), then a lower boundary is logged (block 805), be it a port (FIG. 1, 102) connected lower boundary or a device identified lower boundary. Once logged, the value is increased (block 801) again. By comparison, if the signal tuning device (FIG. 1, 106) determines the state is not more definite (block 804, determination NO), i.e., there is less information available, then an upper boundary is logged (block 806). If the information that is no longer available is a device identity, then the upper boundary may be a device identified upper boundary. By comparison, if the information that is no longer available is a port connection status, then the upper boundary may be a port connected upper boundary. In either case, the setting value is increased (block 801) again. This repeats until the upper threshold for the controller (FIG. 3, 314) is reached (block 802, determination YES).

A specific numeric example is now provided, Table (1) providing a reference. Starting at drive strength 000, the signal tuning device (FIG. 1, 106) increases (block 801) a drive strength to the next value, which is 001. In this example, as the upper threshold is not reached (block 802, determination NO), which upper threshold in the example depicted in Table (1) is drive strength 007, so the signal tuning device (FIG. 1, 106) determines (block 803) if there is a state change. Going from 000 to 001 there is a stage change (Block 803, determination YES), so the signal tuning device (FIG. 1, 106) determines (block 804) if the state is more definite. In this case, the signal tuning device (FIG. 1, 106) determines that the state is more definite (block 804, determination YES) on account of the port (FIG. 1, 102) connection state now being readable, so the signal tuning device (FIG. 1, 106) logs (block 805) this as a lower boundary specifically, a lower boundary port (FIG. 1, 102) connected value.

TABLE 1

| Driving | Port | Device | |
|---|---|---|---|
| Strength | Connection | Identified | Boundary |
| 000 | | | |
| 001 | X | | Port Connected Lower |
| | | | Boundary |
| 002 | X | X | Device Identified Lower |
| | | | Boundary |
| 003 | X | X | Target Value |
| 004 | X | X | Device Identified Upper |
| | | | Boundary |
| 005 | X | | Port Connected Upper |
| | | | Boundary |
| 006 | | | |
| 007 | | | |

The signal tuning device (FIG. 1, 106) increases (block 801) the drive strength to the next value, which is 002. The upper threshold is not reached (block 802, determination NO), so the signal tuning device (FIG. 1, 106) determines (block 803) if there is a state change. Going from 001 to 002 there is a stage change (Block 803, determination YES), so the signal tuning device (FIG. 1, 106) determines (block 804) if the state is more definite. In this case, the signal tuning device (FIG. 1, 106) determines that the state is more definite (block 804, determination YES) on account of the port (FIG. 1, 102) connection state being readable and the device being identifiable, so the signal tuning device (FIG. 1, 106) logs (block 805) this as a lower boundary specifically, a lower device identified value.

The signal tuning device (FIG. 1, 106) increases (block 801) the drive strength to the next value, which is 003. The signal tuning device (FIG. 1, 106) determines that the upper threshold is not reached (block 802, determination NO), so the signal tuning device (FIG. 1, 106) determines (block 803) if there is a state change. Going from 002 to 003 there is no stage change (Block 803, determination NO), so the signal tuning device (FIG. 1, 106) increases (block 801) to the next value, which is 004.

The signal tuning device (FIG. 1, 106) determines that the upper threshold is not reached (block 802, determination NO), so the signal tuning device (FIG. 1, 106) determines (block 803) if there is a state change. Going from 003 to 004 there is no stage change (Block 803, determination NO), so the signal tuning device (FIG. 1, 106) increases (block 801) to the next value, which is 005.

The signal tuning device (FIG. 1, 106) determines that the upper threshold is not reached (block 802, determination NO), so the signal tuning device (FIG. 1, 106) determines (block 803) if there is a state change. Going from 004 to 005 there is a stage change (Block 803, determination YES), so the signal tuning device (FIG. 1, 106) determines (block 804) if the state is more definite. In this case, the signal tuning device (FIG. 1, 106) determines that the state is not more definite (block 804, determination NO) on account of the device being no longer identifiable, so the signal tuning device (FIG. 1, 106) continues and logs (block 806) this as an upper boundary specifically, an upper boundary device identified value.

The signal tuning device (FIG. 1, 106) increases (block 801) the drive strength to the next value, which is 006. The upper threshold is not reached (block 802, determination NO), so the signal tuning device (FIG. 1, 106) determines (block 803) if there is a state change. Going from 005 to 006 there is a stage change (Block 803, determination YES), so the signal tuning device (FIG. 1, 106) determines (block 804) if the state is more definite. In this case, the signal tuning device (FIG. 1, 106) determines that the state is not more definite (block 804, determination NO) on account of the port connection state no longer being readable, so the signal tuning device (FIG. 1, 106) logs (block 806) this as an upper boundary specifically, an upper boundary port attached value.

The signal tuning device (FIG. 1, 106) again increases (block 801) the drive strength to the next value, which is 007. The signal tuning device (FIG. 1, 106) determines that the upper threshold is reached (block 802, determination YES), so operation ends. In this example, the boundary levels are levels 003-005 which represent those values for which a port connection status is readable and a device is identifiable. Accordingly, the signal tuning device (FIG. 1, 106) selects a target value, which may be between these values. Accordingly, the signal tuning device (FIG. 1, 106) sets the target value as drive strength 004.

While FIG. 8 depicts an example of tuning a drive strength, the same method (800) may be used to determine a target DC level. That is, for the DC level, different values may be walked through and a first value where the connection state is readable and the peripheral device identifiable is the lower boundary and the upper boundary may be where 1) the peripheral device is no longer identifiable.

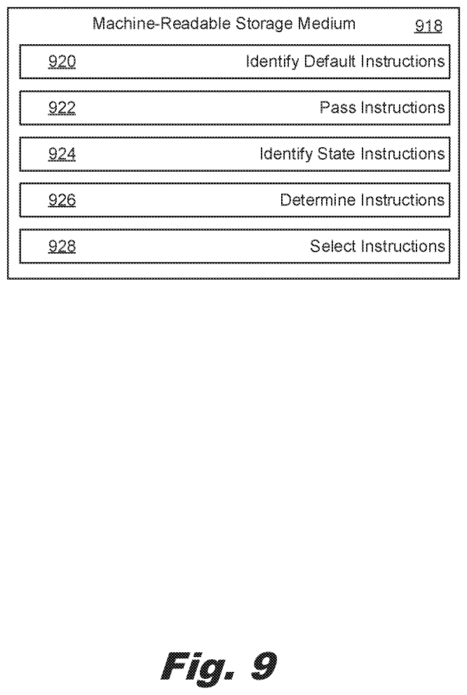

FIG. 9 depicts a non-transitory machine-readable storage medium (918) adjusting target signal settings, according to an example of the principles described herein. To achieve its desired functionality, a compute device (FIG. 1, 100) includes various hardware components. Specifically, a computing system includes a processor and a machine-readable storage medium (918). The machine-readable storage medium (918) is communicatively coupled to the processor. The machine-readable storage medium (918) includes a number of instructions (920, 922, 924, 926, 928) for performing a designated function. In some examples, the instructions may be machine code and/or script code.

The machine-readable storage medium (918) causes the processor to execute the designated function of the instructions (920, 922, 924, 926, 928). The machine-readable storage medium (918) can store data, programs, instructions, or any other machine-readable data that can be utilized to operate the compute device (FIG. 1, 100). Machine-readable storage medium (918) can store machine readable instructions that the processor of the controller (FIG. 3, 314) can process, or execute. The machine-readable storage medium (918) can be an electronic, magnetic, optical, or other physical storage device that contains or stores executable instructions. Machine-readable storage medium (918) may be, for example, Random-Access Memory (RAM), an Electrically Erasable Programmable Read-Only Memory (EEPROM), a storage device, an optical disc, etc. The machine-readable storage medium (918) may be a non-transitory machine-readable storage medium (918).

Referring to FIG. 9, identify default instructions (920), when executed by the processor, cause the processor to, identify a default value for a setting of a signal between a compute device (FIG. 1, 100) and a peripheral device. Pass instructions (922), when executed by the processor, cause the processor to, sequentially pass signals with various settings to the peripheral device.

Identify state instructions (924), when executed by the processor, cause the processor to, identify for which of the various settings a port connection state is readable and a peripheral device connected to the port is identifiable. Determine instructions (926), when executed by the processor, cause the processor to, determine an upper and lower boundary value for the setting where a port connection state is readable and a peripheral device connected to the port is identifiable. Select instructions (928), when executed by the processor, cause the processor to, select, based on the peripheral device, a target value between the upper and lower boundary values, which setting is applied to the signal.

In summary, using such compute devices (FIG. 1, 100), methods, and machine-readable storage mediums may, for example, 1) detect and identify a wide variety of peripheral devices; 2) implement settings for a peripheral device communication that are tailored to the peripheral device; 3) prevent potential damage to the peripheral device and/or compute device via improper settings; and 4) provide compatibility with a wide variety of peripheral devices, as examples. However, it is contemplated that the devices disclosed herein may address other matters and deficiencies in a number of technical areas, for example.

What is claimed is:

1. A compute device, comprising:
a port to receive a connector of a peripheral device;
a signal generator to drive a signal to the peripheral device via the port; and
a signal tuning device to:
determine boundary values for a setting of the signal;
select a target value for the setting, the target value to be between the boundary values; and
adjust the setting of the signal to the target value.

2. The compute device of claim 1, wherein the signal generator comprises a chipset.

3. The compute device of claim 2, wherein the signal generator further comprises a re-driving circuit.

4. The compute device of claim 1, wherein the setting is selected from the group consisting of a drive strength, a disconnect voltage, and a direct current level.

5. The compute device of claim 1, wherein adjustment of the setting to the target value comprises adjustment of a setting of the signal generator.

6. The compute device of claim 1, wherein the signal tuning device comprises:
multiple voltage dividers; and
a controller to select a resistance by activating a subset of the multiple voltage dividers.

7. The compute device of claim 1, wherein the signal tuning device comprises:
a variable resistor; and
a controller to select a resistance for the variable resistor.

8. The compute device of claim 1, wherein the signal tuning device is activated responsive to a connection of the peripheral device to the port.

9. A method, comprising:
determining, via a controller, boundary values for a setting of a signal between a compute device and a peripheral device;
selecting, via the controller, a target value for the setting, wherein the target value is between determined boundary values; and
adjusting, via the controller, the setting of the signal to match the target value.

10. The method of claim 9, further comprising, for each of various setting values, determining whether at that value:
a port connection state is readable; and
a peripheral device connected to the port is identifiable.

11. The method of claim 10, wherein:
determining boundary values for the setting comprises sequentially increasing the setting value to identify those values for which a port connection state is readable and the peripheral device connected to the port is identifiable; and
the boundary values represent those values where a port connection state is readable and the peripheral device connected to the port is identifiable.

12. The method of claim 10, wherein determining boundary values for a disconnect voltage setting comprises:
sequentially increasing the setting value to identify a lower boundary when a peripheral device is disconnected; and
determining an upper boundary from information associated with a peripheral device.

13. The method of claim 9, wherein the target value is an average of an upper boundary value and a lower boundary value.

14. A non-transitory machine-readable storage medium encoded with instructions executable by a processor, the machine-readable storage medium comprising instructions to, when executed by the processor, cause the processor to:
identify a default value for a setting for a signal between a compute device and a peripheral device;
pass signals with various setting values to the peripheral device;
identify for which of the various setting values a port connection state is readable and a peripheral device connected to the port is identifiable;
determine an upper and lower boundary values for the setting where a port connection state is readable and a peripheral device connected to the port is identifiable; and
select, based on the peripheral device, a target value between the upper and lower boundary values, which setting is applied to the signal.

15. The non-transitory machine-readable storage of claim 14, further comprising instructions to, responsive to the peripheral device being connected to the port, recall a respective target value from non-volatile memory.
